(19) United States
(12) Patent Application Publication
(10) Pub. No.: US 2025/0312728 A1
(43) Pub. Date: Oct. 9, 2025

(54) AUTOMATION OF WATER MAKE-UP IN GAS TREATING SYSTEMS TO OPTIMIZE PERFORMANCE

(71) Applicant: SAUDI ARABIAN OIL COMPANY, Dhahran (SA)

(72) Inventors: Farshad Farook, Dhahran (SA); Eisa A. Almakrami, Dhahran (SA)

(73) Assignee: SAUDI ARABIAN OIL COMPANY, Dhahrah (SA)

(21) Appl. No.: 18/628,485

(22) Filed: Apr. 5, 2024

(51) Int. Cl. B01D 53/14; B01D 53/18

(52) U.S. Cl. CPC B01D 53/1412; B01D 53/18; B01D 2252/204

(57) ABSTRACT

Systems and methods to automate addition of make-up water, including a water collection system, at least one gas treating system, and a computer system. The gas treating system includes an inlet gas line and an outlet gas line. The computer system is configured to receive a water flow rate and at least one physical property from the inlet gas and the outlet gas, calculate a total volume of water to be added to the at least one gas treating system, and produce instructions to adjust the water flow rate based on the total volume of water to be added to the at least one gas treating system.

### BACKGROUND

Amine based gas treating systems are common in gas plants that process sour feed gas in order to remove acid gases such as H₂S and CO₂ to meet product specifications. The acid gas removal process is commonly referred to as “sweetening” of natural gas. In the sweetening process, water may be continuously added to the amine system to replace water that is lost as vapor (evaporative losses) and due to water entrainment in the treated and acid gas streams. Makeup is usually accomplished by periodic manual adjustment basis inventory, with determination of free amine strength at sufficient frequency to ensure operation within established limits. Amine based gas treating is a process that is widely used in refineries, petrochemical plants, natural gas processing plants, and other applications. Amine gas treating, also known as amine scrubbing, gas sweetening, and acid gas removal, is a process that uses an aqueous amine solution to remove hydrogen sulfide, carbon dioxide, and other “acid gases”, from hydrocarbon gas streams. Gas streams containing one or more of the acid gases may be referred to as “sour gas” whether it is from a natural or a fabricated source.

Hydrogen sulfide and carbon dioxide can have separate, individual, commercial value. For example, hydrogen sulfide may be converted to elemental sulfur, which can be used in various manufacturing processes. Carbon dioxide can be used in enhanced oil recovery processes, particularly in the miscible flooding of oil reservoirs.

Typically, make-up water is recycled water from liquid recovery plants and demineralized water. Manual addition of make-up water generally leads to excessive water in the amine system since the water is not added in proportion to the quantities lost. Manual addition of make-up water eventually leads to continuous loss of amine solvent strength, impacting overall performance of gas treating system and treated gas specifications. Furthermore, excess water in the amine system can be carried to downstream sulfur recovery systems, impacting sulfur plant operation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system to automate addition of make-up water, including a water collection system, where the water collection system includes a level-indicating transmitter, a make-up water line, and a water source. The water source is fluidly connected to an upstream side of the water collection system and the make-up water line exits the water collection system. The system to automate addition of make-up water also includes at least one gas treating system, where the gas treating system includes a flow control valve on an inlet water line, an inlet gas sensor on an inlet gas line, and an outlet gas sensor on an outlet gas line, where the inlet gas line and the inlet water line enter the at least one gas treating system and the outlet gas line exits the at least one gas treating system. The gas treating system also includes a flow meter on an adjusted make-up water line, where the flow meter is located between the water collection system and the flow control valve and a computer system. The computer system is configured to receive a water flow rate from the flow meter and at least one physical property from the inlet gas sensor and the outlet gas sensor, calculate a total volume of water to be added to the at least one gas treating system, and produce instructions to adjust, using the flow control valve, the water flow rate based on the total volume of water to be added to the at least one gas treating system. The computer system is in electrical communication with the flow meter, the inlet gas sensor, the outlet gas sensor, and the flow control valve.

In another aspect, embodiments disclosed herein relate to a computer-implemented method for automating addition of make-up water, including receiving a water flow rate from a flow meter and physical property data from an inlet gas sensor and an outlet gas sensor, where the physical property data includes at least one of a gas flow rate, a gas temperature, and a gas pressure, and where the flow meter is located on an inlet water line, the inlet gas sensor is located on an inlet gas line, and the outlet gas sensor is located on an outlet gas line. The method for automating addition of make-up water also includes calculating, using a computer system and using the physical property data, a total volume of water to be added to a gas treating system, where the inlet water line and the inlet gas line enter the gas treating system and the outlet gas line exits the gas treating system. The method for automating addition of make-up water also includes producing instructions to adjust, using a flow control valve, the water flow rate based on the total volume of water to be added to the gas treating system, where the flow control valve is located on the inlet water line at a downstream position from the flow meter and where the computer system is in electrical communication with the flow meter, the inlet gas sensor, the outlet gas sensor, and the flow control valve.

In yet another aspect, embodiments disclosed herein relate to a computer-implemented method for automating addition of make-up water, including receiving a plurality of water flow rates from a plurality of flow meters and physical property data from a plurality of inlet gas sensors and a plurality of outlet gas sensors, where the physical property data includes at least one of a gas flow rate, a gas temperature, and a gas pressure, and where each of the plurality of flow meters is located on an inlet water line, each of the plurality of inlet gas sensors is located on an inlet gas line, and each of the plurality of outlet gas sensors is located on an outlet gas line. The method also includes calculating, using a computer system and using the physical property data, a total volume of water to be added to a plurality of gas treating systems, where the inlet water line and the inlet gas line enter each of the plurality of gas treating systems and the outlet gas line exits each of the plurality of gas treating systems. The method further includes producing instructions to adjust, using a plurality of flow control valves, the plurality of water flow rates, where each of the plurality of flow control valves is located on the inlet water line at a downstream position from each of the plurality of flow meters, and where the computer system is in electrical communication with the plurality of flow meters, the plurality of inlet gas sensors, the plurality of outlet gas sensors, and the plurality of flow control valves.

Other aspects and advantages of the claimed subject matter will be apparent from the following description and the appended claims.

### BRIEF DESCRIPTION OF DRAWINGS

FIG. 1 is an example of a gas treating system in accordance with one or more embodiments.

FIG. 2A shows a system to automate continuously adding make-up water to a gas treating system in accordance with one or more embodiments.

FIG. 2B illustrates a system to automate continuously adding make-up water to a plurality of gas treating systems in accordance with one or more embodiments.

FIG. 3 is a computer system according to one or more embodiments.

FIG. 4A is a flowchart of a computer-implemented method in accordance with one or more embodiments.

FIG. 4B is a flowchart of another computer-implemented method in accordance with one or more embodiments.

### DETAILED DESCRIPTION

Managing water balance during the acid gas removal process is typically necessary for maintaining steady and reliable gas treating operations. Any upset in system water balance will impact amine strength and may lead to significant costs. Design make-up water flow rate cannot be reliably applied to maintain system water balance as it fails to consider the process parameters which drive the water entrainment and evaporative losses, which are train capacity and regenerator overhead temperature, respectively.

Accordingly, there exists a need for an automated addition of make-up water to gas treating systems to prevent amine strength dilution, reduce cost, and prevent issues of excess water in downstream operations. Embodiments described herein relate to systems and methods for automating addition of make-up water to one or more gas treating systems.

One or more embodiments relate to a system for automating addition of make-up water. The system of one or more embodiments includes at least one gas treating system, a water collection system, a make-up water line, and a computer system.

For the purposes of the present disclosure, accompanying components that are conventionally used in the systems described, such as pumps and compressors, gas handling apparatuses, valves, sensors, electronic controllers, heat exchangers, and mixers, may not be shown or discussed for the sake of simplicity, although in an actual operating system these and many more apparatuses and systems would be included. One of ordinary skill in the art appreciates that such components may be included in the embodiments disclosed.

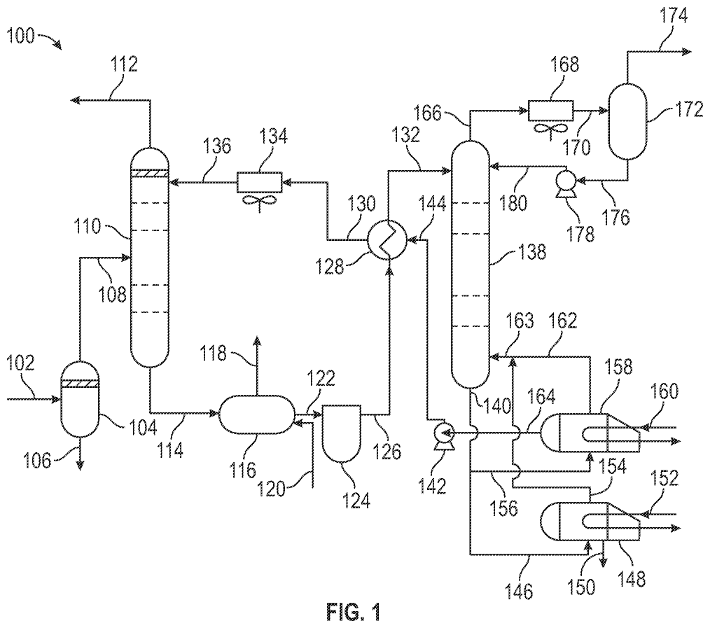

The system of one or more embodiments includes a gas treating system. The gas treating system may be a conventional amine-based gas treating system, for example, the amine-based gas treating system portrayed in FIG, including a make-up water stream entering a flash tank. While FIG. 1 portrays one example of a gas treating system, one of ordinary skill in the art will appreciate that any gas treating system requiring make-up water may be used in the system disclosed herein. In the gas treating system 100 of FIG. 1, a sour gas feed stream 102 enters a liquid/gas separator 104, producing a liquid stream 106 and a gas stream 108. The gas stream 108 enters an absorber system 110, where acid gases are absorbed from the gas stream 108, producing a rich amine stream 114 and a sweet gas stream 112.

In one or more embodiments, the sour gas feed stream 102 may be a light, sour gas. In some embodiments, the sour gas feed stream may include an acid gas portion, and “light” hydrocarbons (C₁₋₆). “Light” hydrocarbons are defined as being hydrocarbons that occur in the gas phase at room temperature and pressure conditions. In some embodiments, the sour gas feed stream may include H₂S and light hydrocarbons. In some embodiments, the sour gas feed stream may include H₂S, CO₂, and light hydrocarbons. In some embodiments, the sour gas feed stream may contain trace amounts of H₂ or may be free from H₂. “Trace” amounts are defined herein as a very small amount, such as less than 0.1 mol %. For example, trace amounts may be less than 0.1 mol %, less than 0.05 mol %, less than 0.01 mol %, or less than 0.001 mol %. Filters may be installed to prevent hydrocarbons having more than 6 carbons (i.e., greater than C₆) from entering gas treating units to prevent foaming.

In some embodiments, the sour gas feed stream may be derived from a light or heavy hydrocarbon hydrotreating unit. In some other embodiments systems, the sour gas feed stream originates from a hydrocracker unit. The reaction system for hydrotreating and hydrocracking units uses high-pressure hydrogen in the presence of a catalyst to hydrodesulfurize or hydrocrack, respectively, a hydrocarbon feed. This post-reaction gas stream (after separation from the hydrocarbon stream of the hydrotreater or hydrocracker) is rich in hydrogen sulfide and some light hydrocarbons.

The sour gas feed stream may have a C₁₋₆ concentration that is in a range of a significant to substantial portion of the feed. In one or more embodiments, the sour gas feed stream may be comprised of C₁₋₆ in a concentration having a range of from about 80 mol % to about 90 mol %. In one or more embodiments, the sour gas feed stream may have a C₁₋₆ concentration in a range having a lower limit of any one of 80, 82 and 85 mol %, and an upper limit of any of 87, 89 and 90 mol %, where any lower limit may be used in combination with any mathematically-compatible upper limit.

The acid gas portion of the sour gas feed stream may include H₂S, carbon dioxide (CO₂), or a combination of H₂S and CO₂. The acid gas portion may be in a range of from about 10 mol % to about 20 mol % of the sour gas feed stream. For example, the acid gas portion may be included in the sour gas feed stream in a range having a lower limit of any one of 10, 12, and 15 mol %, and an upper limit of any of 117 and 20 mol %, where any lower limit may be used in combination with any mathematically-compatible upper limit. In some embodiments, the acid gas portion of the sour gas feed stream may include only H₂S. In some embodiments, the acid gas portion of the sour gas feed stream may be primarily H₂S with CO₂. For example the acid gas portion may contain about 80 mol % H₂S and 20 mol % CO₂, or about 90 mol % H₂S and 10 mol % CO₂, or about 95 mol % H₂S and 5 mol % CO₂, or about 99 mol % H₂S and 1 mol % CO₂, or about 100 mol % H₂S.

The pressure and temperature of the sour gas feed stream will generally depend on the system(s) from which it originates, such as from a hydrocracker unit, a naphtha hydrotreating unit, or a diesel hydrotreating unit. In one or more embodiments, the sour gas feed stream may have a pressure in a range of from about 15 to about 70 bars. In one or more embodiments, the sour gas feed stream may have a pressure in a range having a lower limit of any of 15, 25, and 35 bar, and an upper limit of any of 40, 50, and 70 bar, where any lower limit may be used in combination with any mathematically-compatible upper limit. In one or more embodiments, the sour gas feed stream may have a temperature ranging from about 40 to 60° C. In one or more embodiments, the sour gas feed stream may have a temperature in a range having a lower limit of any of 40, 45, 50, and 55° C., and an upper limit of any of 45, 50, 55, and 60° C., where any lower limit may be used in combination with any mathematically-compatible upper limit.

The liquid/gas separator 104 of one or more embodiments may be any liquid/gas separator know in the art. A liquid/gas separator is typically a pressure vessel used for separating a stream into gaseous and liquid components. The liquid/gas separator may be divided into horizontal, vertical, or spherical separators. The liquid/gas separator may include a first stage and a second stage configured to separate liquids and gases or a first stage, a second stage, and a third stage configured to separate oil, gas, and water. A liquid/gas separated may also be referred to as a deliquilizer or a degasser, and these terms will be understood according to one or more embodiments as referring to an equivalent device.

The liquid stream 106 of one or more embodiments includes a variety of components, including liquid hydrocarbons and water. The liquid stream is not limited to these components and may include any additional liquids present in the sour gas stream capable of being separated by the liquid/gas separator.

The gas stream 108 of one or more embodiments includes one or more of H₂S, CO₂, light hydrocarbons, and the like. The gas stream is not limited to these components and may include any additional gases present in the sour gas stream capable of being separated by the liquid/gas separator.

In one or more embodiments, the absorber system 110 may be a cylindrical column or tower that is equipped with a gas stream inlet and a gas-distributing device, such as a gas sparger, at the bottom of the column. The absorber system further includes a lean amine liquid distributor device, such as shower nozzles, at the top of the column. The column is also configured such that there is sufficient mass transfer surface area for the absorption to occur. Common column internal structures, such as distillation trays, structured packing, and random packing, are envisioned. In some embodiments, because sour gas feed is generally less dense than the lean amine solution, the introduction of the sour gas feed at the bottom of the absorber and the lean amine solution at the top of the absorber results in counter-flow contact as the gas rises and the liquid lean amine solution falls.

In one or more embodiments, the absorber system may have a temperature ranging from about 40 to 50° C. In further embodiments, the absorber system may have a temperature in a range having a lower limit of any of 40, 41, 42, 45, 46, 48, and 49° C., and an upper limit of any of 41, 42, 45, 46, 48, 49, and 50° C., where any lower limit may be used in combination with any mathematically-compatible upper limit. In some embodiments, the temperature differential across the absorber system may be about 10 Δ° C.

In one or more embodiments, the absorber system may have a pressure ranging from about 14 bar to 70 bar. For example, the pressure of the absorber system may be maintained at about 14 bars if the sour gas feed originates from naphtha hydrocarbon hydrotreater process, whereas the pressure may be maintained at about 70 bars if the sour gas feed originates from a vacuum gas oil hydrocracking process. In further embodiments, the absorber system may have a pressure in a range having a lower limit of any of 14, 16, 18, 20, and 25 bars, and an upper limit of any of 30, 40, 50, 60, and 70 bar, where any lower limit may be used in combination with any mathematically-compatible upper limit. In some embodiments, the pressure differential across the absorber system may be about 1 Δbar. The sour gas feed bay be letdown to lower pressures in the aforementioned range before being sent to a gas processing plant.

In one or more embodiments, the sweet gas stream 112 results from the absorber system 110 (shown in FIG. 1), where a portion of acid gas present in the sour gas feed stream 102 is absorbed and reacted with an amine solution present in the absorber system 110 and the removal of acid gases “sweetens” the sour gas feed stream 102. In one or more embodiments, due to transport phenomenon at the absorber system 110 conditions, a small amount of other gases, such as hydrogen and light hydrocarbons dissolve into the amine solution. These compounds, unlike the sour gases, do not react with the amines in the amine solution.

In one or more embodiments, the absorber system 110 may remove about 95 to 98 mol % of the CO₂ introduced with the sour gas feed stream. In further embodiments, the HP absorber may remove an amount of hydrogen sulfide on a mole basis in a range having a lower limit of any of 95, 95.5, and 96%, and an upper limit of any of 96.5, 97, and 98%, where any lower limit may be used in combination with any mathematically-compatible upper limit.

The sweet gas stream 112 may have a C₁₋₆ concentration that is in a range of from a significant to substantial portion of the total composition of the sweet gas stream. In one or more embodiments, the sweet gas stream may be comprised of C₁₋₆ in a concentration having a range of from about 95 mol % to about 99 mol %. In one or more embodiments, the sweet gas stream may have a C₁₋₆ concentration in a range having a lower limit of any one of 95, 97.5, and 98 mol %, and an upper limit of any of 98.5 and 99 mol %, where any lower limit may be used in combination with any mathematically-compatible upper limit.

The sweet gas stream may have an H₂S concentration that is zero or a trace amount of the total composition of the sweet gas stream. In one or more embodiments, the sweet gas stream may be comprised of hydrogen sulfide in a concertation having a range of from about 0.001 mol % to about 0.1 mol %. In one or more embodiments, the sweet gas stream may have a hydrogen sulfide concentration in a range having a lower limit of any one of 0.001, 0.005, 0.01, and 0.05 mol %, and an upper limit of any of 0.005, 0.01, 0.05 and 0.1 mol %, where any lower limit may be used in combination with any mathematically-compatible upper limit.

The rich amine stream 114 according to one or more embodiments includes rich amine, water, free hydrogen sulfide (H₂S), and light hydrocarbons. As used herein, the term “free H₂S” is defined as H₂S which is unreacted with amines and therefore merely dissolved in water. The term “rich amine” refers to amine saturated with H₂S and CO₂.

Keeping with FIG. 1, the rich amine stream 114 then enters a flash tank 116, where the flash tank 116 is configured to rapidly reduce the pressure of the rich amine stream 114, producing a flashed gas stream 118 and a flashed rich amine stream 122. In one or more embodiments, make-up water stream 120 is added to the flash tank 116.

In one or more embodiments, the flash tank 116 is operated at a reduced pressure compared to the absorber system. This causes the introduced rich amine stream to drop from a greater pressure condition to a reduced pressure condition, creating the “flash” that results in gases escaping the rich amine stream through a turbulent boil. In some configurations of the flash drum, internal structures spread the introduced rich amine stream thinly so that the amount of distance a coalescing gas in the liquid travels to the surface of the liquid and into the gas phase is reduced, facilitating degassing of the liquid. Atomizing nozzles, packing, distributor plates, and “smash” or “slam” plates (that is, a sacrificial barrier that the fluid is introduced onto to spray the liquid thinly in all directions) are known and appreciated.

The flash tank of one or more embodiments will generally operate at a pressure that is less than the absorber system but at a pressure greater than the regenerator system. This facilitates introduction of the rich amine stream into the flash tank and the passing of flashed gas stream into the LP absorber unit without a pump or compressor. In an embodiment, the flash tank is maintained at a pressure greater than the regenerator system, such a pressure differential being in a range of from about 1 Δbar to about 3 Δbars, such as about 1 Δbar, about 1.5 Δbars, about 2 Δbars, and about 3 Δbars.

In one or more embodiments, the flash tank may have a pressure ranging from about 9 to about 13 bars, such as about 9, about 10, about 11, about 12 and about 13. In further embodiments, the flash drum may have a pressure in a range having a lower limit of any of 9, 10, 11, and 12, to an upper limit of any of 10, 11, 12, and 13 bars, where any lower limit may be used in combination with any mathematically-compatible upper limit.

In one or more embodiments, the flash tank is maintained at a temperature less than the absorber system, such a temperature differential being in a range of from about 0.1 Δ° C. to about 3 Δ° C., such as about 1 Δ° C., about 1.5 Δ° C., about 2 Δ° C., and about 3 A° C. This differential is due in part to the flashing effect that occurs in the flash tank.

The flashed rich amine stream 122 of one or more embodiments, may include similar components to the rich amine stream 114 from which it originates. For example, the flashed rich amine stream may be primarily composed of rich amine solution and water.

In one or more embodiments, the make-up water stream 120 may be sourced from fresh water, demineralized water, recycled water from liquid recovery plants, and the like. The make-up water stream of one or more embodiments may originate from a single source or plurality of sources, where water from the plurality of sources may be supplied to a mixing tank or a holding tank prior to entering an amine-based gas treating system or may enter into the amine-based gas treating system directly from each respective source.

In one or more embodiments, the flashed gas stream 118 may have a C₁₋₆ concentration that is a significant portion of the total composition of the flashed gas stream. In one or more embodiments, the flashed gas stream may be comprised of C₁₋₆ in a concentration having a range of from about 80 mol % to about 90 mol %. In one or more embodiments, the flashed gas stream may be comprised of C₁₋₆ concentration in a range having a lower limit of any one of 80, 82, and 84 mol %, and an upper limit of any of 86, 88, and 90 mol %, where any lower limit may be used in combination with any mathematically-compatible upper limit.

The flashed gas stream may have an H₂S concentration that is a substantial portion of the total composition of the flashed gas stream. In one or more embodiments, the flashed gas stream may be comprised of hydrogen sulfide in a concertation having a range of from about 10 mol % to about 20 mol %. In one or more embodiments, the flashed gas stream may have a hydrogen sulfide concentration in a range having a lower limit of any one of 10, 12, and 15 mol %, and an upper limit of any of 17, 19, and 20 mol %, where any lower limit may be used in combination with any mathematically-compatible upper limit. The flashed gas stream may have a CO₂ concentration that is an incidental portion of the total composition of the flashed gas stream.

Keeping with FIG. 1, the flashed rich amine stream 122 is then sent to a filtration system 124 and a filtered rich amine stream 126 is produced. The filtered rich amine stream 126 is sent to a lean-rich heat exchanger 128 and a pre-heated rich amine stream 132 is produced.

The filtration system 124 of one or more embodiments may include any filtration system known in the art, for example, a cartridge filter, a high capacity cartridge filter, a bag filter, a string wound filter, or the like.

The filtered rich amine stream 126 of one or more embodiments, may include similar components to the flashed rich amine stream 122 and the rich amine stream 114 from which it originates. For example, the flashed rich amine stream may be primarily composed of rich amine solution and water.

The lean-rich heat exchanger 128 of one or more embodiments may be any suitable heat exchanger known in the art. For example, the lean-rich heat exchanger may be a finned tube heat exchanger, an air cooled heat exchanger, a shell and tube heat exchanger, a plate heat exchanger or a gasket plate heat exchanger, or combinations thereof.

Keeping with FIG. 1, the pre-heated rich amine stream 132 then enters a regenerator system 138 where additional H₂S an CO₂ are removed from the pre-heated rich amine stream 132, producing a regenerated lean amine stream 140 and a regenerated gas stream 166.

In one or more embodiments, the regenerator system 138 is configured such that the streams entering the regenerator system 138 intimately intermingle to allow absorption of acid gases. The structure and operation of the regenerator system 138 may be like that of the absorber system 110 except for the operating conditions, which are at reduced conditions comparatively. At least a portion of the acid gases, such as hydrogen sulfide and CO₂, contained in the pre-heated rich amine stream 132 is extracted and absorbed by anamine solution in the lean amine absorber. The dissolved hydrogen sulfide and CO₂ then reacts with the amine and prevents it from coming out of solution. The resultant products of the exchange are regenerated lean amine stream 140 and a regenerated gas stream 166.

The regenerator system 138 is operated at a reduced temperature compared to the absorber system 110. In one or more embodiments, the regenerator system 138 may have a temperature ranging from about 30 to about 45° C. In further embodiments, the regenerator system 138 may have a temperature in a range having a lower limit of any of 30, 33, 36, 39, and 42° C., to and an upper limit of any of 33, 36, 39, 42, and 45° C., where any lower limit may be used in combination with any mathematically-compatible upper limit. In some embodiments, the temperature differential across the regenerator system 138 may be about 10 Δ° C.

The regenerator system 138 is operated at a reduced pressure compared to absorber system 110 and the flash tank 116. In one or more embodiments, the regenerator system 138 may have a pressure ranging from about 7 to about 11 bar. In further embodiments, the regenerator system 138 may have a pressure in a range having a lower limit of any of 7, 8, 9, and 10 bar, to an upper limit of any of 8, 9, 10, and 11 bar, where any lower limit may be used in combination with any mathematically-compatible upper limit. In some embodiments, the pressure differential across the regenerator system 138 may be about 1 Δbar.

In one or more embodiments, the regenerator system 138 may remove about 99.95 to about 99.99 mole % of the hydrogen sulfide introduced with pre-heated rich amine stream 132. In further embodiments, the regenerator system 138 may remove an amount of hydrogen sulfide on a mole basis in a range having a lower limit of any of 99.95, 99.96, 99.97 and 99.98 mole %, to an upper limit of any of 99.96, 99.97, 99.98, and 99.99 mole %, where any lower limit may be used in combination with any mathematically-compatible upper limit.

The regenerated lean amine stream 140 of one or more embodiments includes amine, water, residual light hydrocarbon gases, and residual free H₂S. The regenerated gas stream 166 of one or more embodiments includes primarily light hydrocarbons.

Keeping with FIG. 1, the regenerated gas stream 166 enters a first air cooled heat exchanger 168, producing a cooled, regenerated gas stream 170 which enters a reflux system 172. The reflux system 172 produces arecycle gas stream 174 and a condensed liquid stream 176. The condensed liquid stream 176 is pumped by a first pump 178 to a condensed liquid recycle stream 180 which enters the regenerator system 138.

The first air cooled heat exchanger 168 of one or more embodiments may be any suitable air cooled heat exchanger known in the art. For example, the air cooled heat exchanger may be an induced draft unit, a forced draft unit, or any other device known in the art.

The cooled, regenerated gas stream 170 of one or more embodiments includes similar components to the regenerated acid gas stream 166 from which it originates. For example, the cooled, regenerated acid gas stream 170 of one or more embodiments includes primarily light hydrocarbons.

The condensed liquid stream 176 and the condensed liquid recycle stream 180 of one or more embodiments includes primarily condensed water and condensed amine solution.

In one or more embodiments, the reflux system 172 may include a condenser, an accumulator, and a pump. In a conventional reflux system, a fluid is removed from a vessel, condensed, and returned to the vessel to enhance the process. Overhead vapor from the stripper mainly consisting of water vapor and acid gases passe through the reflux condenser which condenses a majority of the water vapor and small amount of amine solution, which may vaporize in the stripper. This two phase stream flows to the reflux accumulator where the acid gases are separated from the condensed liquid. The acid gases may be sent either to flare stack or sulfur recovery plant depending on the amount of hydrogen sulfide present. The condensed liquids are pumped to the top of the stripper to reflux. The reflux system of one or more embodiments accomplishes two things in the overhead system of the stripper-first it causes vapor in the top of the stripper to reduce amine carryover, and second, it cools the acid gas in the top of the stripper to reduce its corrosiveness.

In one or more embodiments, the recycle gas stream 174 may contain primarily light hydrocarbons.

The first pump 178 of one or more embodiments is any suitable pump known in the art. For example, the first pump 178 may be a centrifugal circulating pump.

Keeping with FIG. 1, the regenerated lean amine stream 140 is split into a first split amine stream 146 and a second split amine stream 156. The first split amine stream 146 enters a reclaimer system 148 which is heated by a first steam source 152. The reclaimer system 148 produces a reclaimed liquid stream 150 and a reclaimed gas stream 154.

The first split amine stream 146 of one or more embodiments may include similar components to the regenerated lean amine stream 140 from which it originates. For example, the second split amine stream may be primarily composed of rich amine, water, residual light hydrocarbon gases, and residual free H₂S.

In one or more embodiments, the reclaimer system 148 may include a basic solution, soda ash, and/or caustic soda. The reclaimer system of one or more embodiments helps remove degradation products from solution and aids in the removal of heat-stable salts, suspended solids, acids, and iron compounds. Reclaimer systems generally operate on a side stream of 1-3% of the total amine circulation rate. Reclaimer sizing depends on the total inventory of the plant and the rate of degradation expected. The reclaimer system of one or more embodiments may perform vacuum distillation on batches of spent amine mixed with sufficient caustic ability to neutralize the excess acidity. The reclaimer system may also use ion exchange resin beds to remove heat-stable salts.

The first steam source 152 of one or more embodiments may have a temperature and pressure sufficient to vaporize the first split amine stream 146 in the reclaimer system 148. Upon vaporizing the first split amine stream 146, a reclaimed liquid stream 150 is produced. The reclaimed liquid stream 150 of one or more embodiments includes water and residual light hydrocarbons. The reclaimed gas stream 154 of one or more embodiments includes amine and residual light hydrocarbon gases.

Keeping with FIG. 1, the second split amine stream 156 enters a reboiler system 158 which is heated by a second steam source 160. The reboiler system 158 produces a reboiled liquid stream 164 and a reboiled gas stream 162. The reclaimed gas stream 154 and the reboiled gas stream 162 are combined into a combined gas stream 163. The combined gas stream is fed back into the regenerator system 138. The reboiled liquid stream 164 is pumped by a second pump 142 to a lean amine recycle stream 144 which enters the lean-rich heat exchanger 128, producing a pre-cooled lean amine recycle stream 130. The pre-cooled lean amine recycle stream 130 enters a second air cooled heat exchanger 134 producing a lean amine stream 136. The lean amine stream 136 enters the absorber system 110.

The second split amine stream 156 of one or more embodiments includes similar components to the regenerated lean amine stream 140 from which it originates. For example, the second split amine stream may be primarily composed of rich amine, water, residual light hydrocarbon gases, and residual free H₂S.

The second steam source 160 of one or more embodiments has a temperature and pressure sufficient to vaporize the second split amine stream 156 in the reboiler system 158. Upon vaporizing a second split amine stream 156, a reboiled gas stream 162 and a reboiled liquid stream 164 are produced. The reboiled gas stream 162 of one or more embodiments may be an acid gas stream including similar components to the second split amine stream 156 from which it originates. For example, the second split amine stream may be primarily composed of rich amine, water, residual light hydrocarbon gases, and residual free H₂S.

The reboiled liquid stream 164, the lean amine recycle stream 144 and the pre-cooled lean amine recycle stream 130 of one or more embodiments include similar components to the lean amine recycle stream 144 from which it originates. For example, the lean amine recycle stream and the pre-cooled lean amine recycle stream may include amines configured for having reversible reactions with hydrogen sulfide or carbon dioxide, or both. The aqueous fluid of the lean amine solution may include at least one of fresh waters, condensate, and mixtures thereof. The combined gas stream 163 of one or more embodiments includes similar components to those of streams 154 and 162, which mix to produce the combined gas stream 163. For example, the combined gas stream 163 may be primarily composed of rich amine, water, residual light hydrocarbon gases, and residual free H₂S.

The lean amine stream 136 may be an aqueous solution comprising one or more amines configured for having reversible reactions with hydrogen sulfide or carbon dioxide, or both. The aqueous fluid of the lean amine solution may include at least one of fresh waters, condensate, and mixtures thereof.

In one or more embodiments, the reboiler system 158 is any suitable reboiler system known in the art which is capable of removing acid gas and recycling a rich amine mixture into a clean stream that is again ready for processing. For example, the reboiler system may be a thermal fluid heating system, a process bath heater system, or an electric process heater system.

The second pump 142 may be any of the pump types as described above. The second air cooled heat exchanger 134 may be any suitable heat exchanger known in the art, as described above.

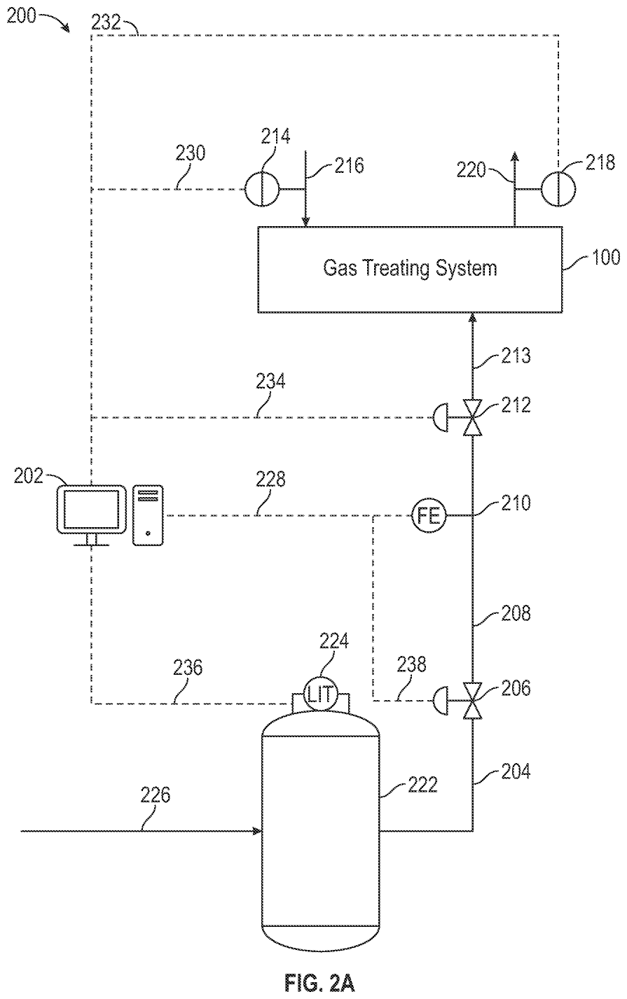

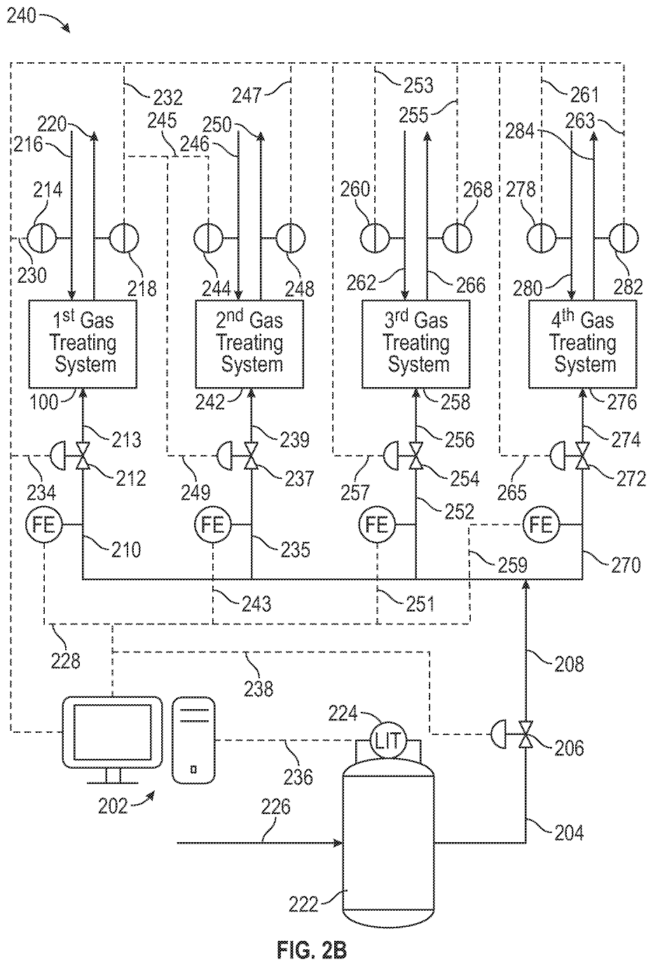

FIG. 2A illustrates an overall system for automating addition of make-up water according to one or more embodiments. The system 200 of FIG. 2A includes a gas treating system 100; for example, the gas treating system described in FIG. 1. The system 200 also includes a water collection system 222, an adjusted make-up water line 208, and a computer system 202.

The gas treating system 100 of FIG. 2A includes an inlet gas line 216 entering the gas treating system 100. In some embodiments, the inlet gas line 216 includes a plurality of inlet gas lines, depending on the specific gas treating system 100 to which make-up water is added. In the example of FIG. 1, an inlet gas line 216 is depicted as the sour gas feed stream 102. The inlet gas line 216 may include, for example, H₂, H₂S, “light” hydrocarbons (C₁₋₆), and any other component entering the specific gas treating system. As noted previously, the example streams and stream components of FIG. 1 are merely an example and are not to be taken as limiting.

The gas treating system 100 of FIG. 2A includes an outlet gas line 220 exiting the gas treating system 100. In some embodiments, the outlet gas line 220 includes a plurality of outlet gas lines, depending on the specific gas treating system 100 to which make-up water is added. The example of FIG. 1 shows a plurality of outlet gas lines, including a sweet gas stream 112, a flashed gas stream 118, and an acid gas stream 174. The outlet gas line 220 of FIG. 2A, therefore, may include H₂, H₂S, light hydrocarbons, and the like. As noted previously, the example streams and stream components of FIG. 1 are merely an example and are not to be taken as limiting.

The inlet gas line 216 includes an inlet gas sensor 214 and the outlet gas line 220 includes an outlet gas sensor 218. The inlet gas sensor 214 and the outlet gas sensor 218 are configured to measure at least one physical property of a gas. When the gas treating system 100 includes a plurality of inlet gas lines and/or a plurality of outlet gas lines, each of the gas lines may also include a gas sensor configured to measure at least one physical property. Additionally, there may be more than one gas sensor on each of the gas lines, each configured to measure one or more physical properties of the gas.

In one or more embodiments, a gas sensor refers to a component configured to measure at least one physical property including a gas temperature, a gas pressure, and a gas flowrate. After observing a change in physical property, the gas sensor sends the detected input to a microcontroller or microprocessor. The gas sensor produces a readable output signal, which can be either optical, electrical, or any form of signal that corresponds to changes in input signal. The gas sensor may include any sensor known in the art which is configured to measure at least one physical property of a gas. For example, the gas sensor may be an active sensor, a passive sensor, an analog sensor, a digital sensor, or combinations thereof.

The gas treating system 100 shown in FIG. 2A is fluidly connected to an inlet water line 213 entering the gas treating system 100. In one or more embodiments, the inlet water line 213 of FIG. 2A is the make-up water stream 120 shown in FIG. 1. The inlet water line 213 includes a flow control valve 212 configured to adjust a water flow rate of water in the inlet water line 213.

The flow control valve 212 may be any flow control valve known in the art. In one or more embodiments, the flow control valve may be an automatic flow control valve which is configured to receive instructions related to adjust a flow rate, for example, from a computer system, and may be automatically operated to adjust the flow rate of a fluid stream according to the received instructions. In one or more embodiments, the flow control valve may be manually operated. A flow control valve may also be referred to as a flow regulator or flow controller, and these terms are to be understood according to one or more embodiments as referring to the same device. The flow control valve of one or more embodiments may include, for example, a ball valve, a check valve, a butterfly valve, a globe valve, a gate valve, a needle valve, and combinations therein. The flow ratio controller of one or more embodiments may include any suitable flow ration controller known in the art. The flow control valve may include a valve, or the flow control valve may be a flow control system, which may include both a flow control valve and a flow ratio controller configured to operate the flow control valve based on instructions received from a computer system.

The system 200 for automating addition of make-up water of one or more embodiments also includes a water collection system 222. The water collection system 222 includes a level-indicating transmitter 224 configured to measure a water level of the water collection system 222. The water collection system 222 includes a water source 226 fluidly connected to an upstream side of the water collection system 222. The water collection system 222 also includes a make-up water line 204 exiting the water collection system 222.

In one or more embodiments, the water source 226 includes fresh water, demineralized water, recycled water from liquid recovery plants, and the like. The water source 226 of one or more embodiments may originate from a single source or plurality of sources prior to entering the water collection system 222.

The make-up water line 204 exiting the water collection system 222 includes a level control valve 206, configured to maintain a desired water level in the water collection system 222. The level control valve 206 is located on the make-up water line 204 at an upstream position from an adjusted make-up water line 208, such that a flow rate of water in the make-up water line 204 may be adjusted to produce an adjusted flow rate of water in the adjusted make-up water line 208.

The adjusted make-up water line 208 of one or more embodiments includes a flow meter 210, configured to measure a water flow rate. The flow meter 210 is located at a position between the water collection system 222 and the flow control valve 212. Specifically, the flow meter 210 is located on the adjusted make-up water line 208 downstream from the level control valve 206 and upstream from the flow control valve 212.

The level control valve 206 may be any level control valve known in the art. In one or more embodiments, for example, the level control valve 206 is a mechanical float mechanism which operates a pilot valve to maintain a water level when a change in water level is detected.

The flow meter 210 may be any flow meter known in the art capable of measuring a fluid flow rate. The flow meter of one or more embodiments may be an ultrasonic flow meter, a vortex flow meter, a magnetic flow meter, a turbine flow meter, a paddle wheel flow meter, and the like.

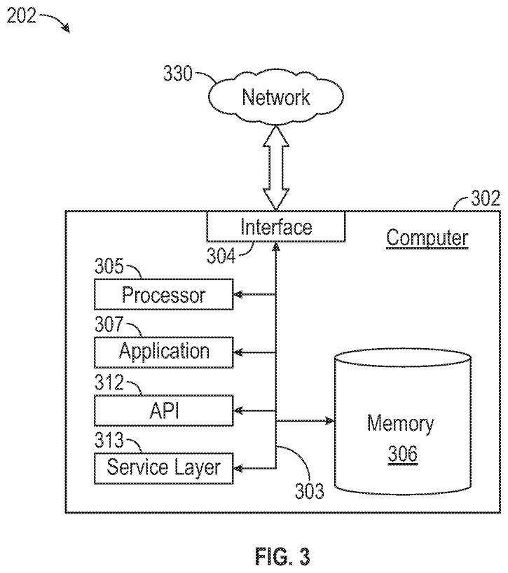

The system 200 for automating addition of make-up water of one or more embodiments also includes a computer system 202. The components of the computer system 202 will be described in more detail in FIG. 3.

The computer system 202 of one or more embodiments is in electrical communication with the elements of the system 200 for automating addition of make-up water of one or more embodiments. Electrical communication according to one or more embodiments may be physical, for example hardwired, or wireless, for example by Bluetooth. Electrical connections are depicted in FIG. 2A by dashed lines and, as is to be understood by one of ordinary skill in the art, the dashed lines represent an electrical communication between the computer system 202 and/or other elements and may be a mixture of physical and wireless communication methods. In one or more embodiments, the computer system 202 is electrically connected to the flow meter 210 by a first electrical communication 228. In one or more embodiments, the computer system 202 is electrically connected to the inlet gas sensor 214 by a second electrical communication 230. In one or more embodiments, the computer system 202 is electrically connected to the outlet gas sensor 218 by a third electrical communication 232. In one or more embodiments, the computer system 202 is electrically connected to the flow control valve 212 by a fourth electrical communication 234. In one or more embodiments, the computer system 202 is electrically connected to the level-indicating transmitter 224 by a fifth electrical communication 236. In one or more embodiments, the computer system 202 is electrically connected to the level control valve by a sixth electrical communication 238.

In one or more embodiments, the computer system 202 is configured to receive a water flow rate from the flow meter 210 and at least one physical property from the inlet gas sensor 214 and the outlet gas sensor 218. Once the water flow rate and the physical properties from the inlet gas sensor 214 and the outlet gas sensor 218 are received by the computer system 202, the computer system may calculate a total volume of water to be added to the gas treating system 100. In one or more embodiments, the computer system 202 is further configured to produce instructions to adjust, using the flow control valve 212, the water flow rate as measured by the flow meter 210 based on the total volume of water to be added to the gas treating system 100.

In one or more embodiments, the computer system 202 is further configured to calculate, using the at least one physical property from the inlet gas sensor 214, a mol % of water present in the inlet gas line 216 and a total volume of water added to the gas treating system 100 from the inlet gas line 216. The computer system 202 may be further configured to calculate, using the at least one physical property from the outlet gas sensor 218, a mol % of water present in the outlet gas line 220 and a total volume of water lost from the gas treating system 100 from the outlet gas line 220. The computer system 202 may then calculate a total volume of water to be added to the gas treating system 100, where the total volume of water to be added to the gas treating system 100 is a difference between the total volume of water lost from the outlet gas line 220 and the total volume of water added from the inlet gas line 216.

Upon calculating the total volume of water to be added to the gas treating system 100, the computer system 202 may be further configured to receive a water level from the level-indicating transmitter 224 on the water collection system 222. In one or more embodiments, the computer system 202 provides instructions to the level control valve 206 to maintain a desired water level in the water collection system 222. The desired water level may be maintained by adjusting a water source flow rate from the water source 226 to match the water flow rate from the flow meter 210 to maintain a constant desired water level in the water collection system 222.

FIG. 2B shows a system 240 for automating make-up water to a plurality of gas treating systems, according to one or more embodiments. The system 240 in FIG. 2B shows an example where four gas treating systems are presented, however, as understood by one of ordinary skill in the art, the system may be applied to any number of gas treating systems.

The system 240 of FIG. 2B may include some of the same components of the system 200 of FIG. 2A. For example, the system 240 may include as a first gas treating system 100, the gas treating system 100 as described in FIG. 1. The system 240 also includes a water collection system 222, an adjusted make-up water line 208, and a computer system 202.

The first gas treating system 100 shown in FIG. 2B includes components as described with regard to FIG. 2A, including an inlet gas line 216 with an inlet gas sensor 214 entering the first gas treating system 100 and an outlet gas line 220 with an outlet gas sensor 218 exiting the first gas treating system 100. In some embodiments, the inlet gas line 216 includes a plurality of inlet gas lines, and the outlet gas line 220 includes a plurality of outlet gas lines, as previously discussed.

The inlet gas sensor 214 and the outlet gas sensor 218 are configured to measure at least one physical property of a gas. When the gas treating system 100 includes a plurality of inlet gas lines and/or a plurality of outlet gas lines, each of the gas lines also includes a gas sensor configured to measure at least one physical property, including a gas temperature, a gas pressure, and a gas flowrate. Additionally, there may be more than one gas sensor on each of the gas lines, each configured to measure one or more physical properties of the gas. The gas sensors of FIG. 2B may be any of the sensors described previously and are configured to measure at least one physical property of a gas.

The system 240 of FIG. 2B includes a second gas treating system 242, a third gas treating system 258, and a fourth gas treating system 276. Each of the second 242, third 258, and fourth 276 gas treating systems may include an inlet gas line including an inlet gas sensor entering the gas treating system and an outlet gas line including an outlet gas sensor exiting the gas treating system. The second gas treating system 242 may include a second inlet gas line 246 with a second inlet gas sensor 244 and a second outlet gas line 250 with a second outlet gas sensor 248. The third gas treating system 258 may include a third inlet gas line 262 with a third inlet gas sensor 260 and a third outlet gas line 266 with a third outlet gas sensor 268. The fourth gas treating system 276 may include a fourth inlet gas line 280 with a fourth inlet gas sensor 278 and a fourth outlet gas line 284 with a fourth outlet gas sensor 282.

The first gas treating system 100 shown in FIG. 2B is fluidly connected to a first inlet water line 213 entering the gas treating system 100. In one or more embodiments, the first inlet water line 213 of FIG. 2B is the make-up water stream 120 shown in FIG. 1. The first inlet water line 213 includes a first flow control valve 212 configured to adjust a first water flow rate of water in the first inlet water line 213.

The second gas treating system 242 is fluidly connected to a second inlet water line 239 entering the second gas treating system 242. The second inlet water line 239 includes a second flow control valve 237 configured to adjust a second water flow rate of water in the second inlet water line 239.

The third gas treating system 258 is fluidly connected to a third inlet water line 256 entering the third gas treating system 258. The third inlet water line 256 includes a third flow control valve 254 configured to adjust a third water flow rate of water in the third inlet water line 256.

The fourth gas treating system 276 is fluidly connected to a fourth inlet water line 274 entering the fourth gas treating system 276. The fourth inlet water line 274 includes a fourth flow control valve 272 configured to adjust a fourth water flow rate of water in the fourth inlet water line 274.

The first 212, second 236, third 254, and fourth 272 flow control valves may be any flow control valve known in the art, as previously described. The flow control valves may include a valve, or the flow control valve may be a flow control system, which may include both a flow control valve and a flow ratio controller configured to operate the flow control valve based on instructions received from a computer system.

The system 240 for automating addition of make-up water shown in FIG. 2B may also include a water collection system 222. As previously described, the water collection system 222 may include a level-indicating transmitter 224 configured to measure a water level of the water collection system 222. The water collection system 222 includes a water source 226 fluidly connected to an upstream side of the water collection system 222 and a make-up water line 204 exiting the water collection system 222. The make-up water line 204 exiting the water collection system 222 includes a level control valve 206, configured to maintain a desired water level in the water collection system 222. The level control valve 206 is located on the make-up water line 204 at an upstream position from an adjusted make-up water line 208, such that a flow rate of water in the make-up water line 204 may be adjusted to produce an adjusted flow rate of water in the adjusted make-up water line 208. The level control valve 206 and may be any level control valve known in the art, as previously described.

The adjusted make-up water line 208 of the system 240 may be split into multiple water lines, each of which enters a gas treating system. As shown in the system 240 of FIG. 2B, the adjusted make-up water line 208 is split into a first inlet water line 213, a second inlet water line 239, a third inlet water line 256, and a fourth inlet water line 274. The first inlet water line 213 includes a first flow meter 210 located immediately upstream of the first flow control valve 212. The first flow meter 210 is configured to measure a first water flow rate. The second inlet water line 239 includes a second flow meter 235 located immediately upstream of the second flow control valve 237. The second flow meter 235 is configured to measure a second water flow rate. The third inlet water line 256 includes a third flow meter 252 located immediately upstream of the third flow control valve 254. The third flow meter 252 is configured to measure a third water flow rate. The fourth inlet water line 274 includes a fourth flow meter 270 located immediately upstream of the fourth flow control valve 272. The fourth flow meter 270 is configured to measure a fourth water flow rate. The first 210, second 234, third 252, and fourth 270 flow meters may be any flow meter known in the art capable of measuring a fluid flow rate, as previously described.

The system 240 for automating addition of make-up water of one or more embodiments also includes a computer system 202. The components of the computer system 202 will be described in more detail in FIG. 3. As previously described, the computer system 202 of one or more embodiments is in electrical communication with the elements of the system 240 for automating addition of make-up water of one or more embodiments. Electrical communication is defined as described previously with regard to FIG. 2A and are also shown by dashed lines in the system 240 of FIG. 2B.

In one or more embodiments, the computer system 202 is electrically connected to the first flow meter 210 by a first electrical communication 228, to the first inlet gas sensor 214 by a second electrical communication 230, the first outlet gas sensor 218 by a third electrical communication 232, and to the first flow control valve 212 by a fourth electrical communication 234. In one or more embodiments, the computer system 202 is electrically connected to the level-indicating transmitter 224 by a fifth electrical communication 236 and to the level control valve by a sixth electrical communication 238.

In one or more embodiments, the computer system 202 is electrically connected to the second flow meter 235 by a seventh electrical communication 243, to the second inlet gas sensor 244 by an eighth electrical communication 245, the second outlet gas sensor 248 by a ninth electrical communication 247, and to the second flow control valve 237 by a tenth electrical communication 249.

In one or more embodiments, the computer system 202 is electrically connected to the third flow meter 252 by an eleventh electrical communication 251, to the third inlet gas sensor 260 by a twelfth electrical communication 253, the third outlet gas sensor 268 by a thirteenth electrical communication 255, and to the third flow control valve 254 by a fourteenth electrical communication 257.

In one or more embodiments, the computer system 202 is electrically connected to the fourth flow meter 270 by a fifteenth electrical communication 259, to the fourth inlet gas sensor 278 by a sixteenth electrical communication 261, the fourth outlet gas sensor 282 by a seventeenth electrical communication 263, and to the fourth flow control valve 272 by an eighteenth electrical communication 265.

In one or more embodiments, the computer system 202 is configured to receive a first water flow rate from the first flow meter 210, a second water flow rate from a second flow meter 235, a third water flow rate from a third flow meter 252, and a fourth water flow rate from a fourth flow meter 270. The computer system 202 is also configured to receive at least one physical property from the first inlet gas sensor 214, the first outlet gas sensor 218, the second inlet gas sensor 244, the second outlet gas sensor 248, the third inlet gas sensor 260, the third outlet gas sensor 268, the fourth inlet gas sensor 278, and the fourth outlet gas sensor 282. Once the water flow rates and the physical properties from are received by the computer system 202, the computer system may calculate a total volume of water to be added to each of the first 100, second 242, third 258, and fourth 276 gas treating systems.

In one or more embodiments, the computer system 202 is further configured to produce instructions to adjust, using the first flow control valve 212, the first water flow rate as measured by the first flow meter 210 based on the total volume of water to be added to the first gas treating system 100. In one or more embodiments, the computer system 202 is also configured to produce instructions to adjust, using the second flow control valve 237, the second water flow rate as measured by the second flow meter 235 based on the total volume of water to be added to the second gas treating system 242. In one or more embodiments, the computer system 202 is further configured to produce instructions to adjust, using the third flow control valve 254, the third water flow rate as measured by the third flow meter 252 based on the total volume of water to be added to the third gas treating system 258. In one or more embodiments, the computer system 202 is further configured to produce instructions to adjust, using the fourth flow control valve 272, the fourth water flow rate as measured by the fourth flow meter 270 based on the total volume of water to be added to the fourth gas treating system 276.

Upon calculating the total volume of water to be added to the first 100, second 242, third 258, and fourth 276 gas treating systems, the computer system 202 may be further configured to receive a water level from the level-indicating transmitter 224 on the water collection system 222. In one or more embodiments, the computer system 202 provides instructions to the level control valve 206 to maintain a desired water level in the water collection system 222. The desired water level may be maintained by adjusting a water source flow rate from the water source 226 to match a first, second, third, and fourth water flow rate from the first 210, second 234, third 252, and fourth 259 flow meters, respectively to maintain a constant desired water level in the water collection system 222.

FIG. 3 depicts a block diagram of a computer system 202 used to provide computational functionalities associated with described networks, methods, functions, processes, flows, and procedures as described in this disclosure, according to one or more embodiments. The illustrated computer 302 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 302 may include a computer that includes an input device, such as a keypad, keyboard, touch screen, or other device that can accept user information, and an output device that conveys information associated with the operation of the computer 302, including digital data, visual, or audio information (or a combination of information), or a GUI.

The computer 302 can serve in a role as a client, network component, a server, a database or other persistency, or any other component (or a combination of roles) of a computer system for performing the subject matter described in the instant disclosure. The illustrated computer 302 is communicably coupled with a network 330. In some implementations, one or more components of the computer 302 may be configured to operate within environments, including cloud-computing-based, local, global, or other environment (or a combination of environments).

At a high level, the computer 302 is an electronic computing device operable to receive, transmit, process, store, or manage data and information associated with the described subject matter. According to some implementations, the computer 302 may also include or be communicably coupled with an application server, e-mail server, web server, caching server, streaming data server, business intelligence (BI) server, or other server (or a combination of servers).

The computer 302 can receive requests over network 330 from a client application (for example, executing on another computer 302) and responding to the received requests by processing the said requests in an appropriate software application. In addition, requests may also be sent to the computer 302 from internal users (for example, from a command console or by other appropriate access method), external or third-parties, other automated applications, as well as any other appropriate entities, individuals, systems, or computers.

Each of the components of the computer 302 can communicate using a system bus 303. In some implementations, any or all of the components of the computer 302, both hardware or software (or a combination of hardware and software), may interface with each other or the interface 304 (or a combination of both) over the system bus 303 using an application programming interface (API) 312 or a service layer 313 (or a combination of the API 312 and service layer 313). The API 312 may include specifications for routines, data structures, and object classes. The API 312 may be either computer-language independent or dependent and refers to a complete interface, a single function, or even a set of APIs. The service layer 313 provides software services to the computer 302 or other components (whether or not illustrated) that are communicably coupled to the computer 302. The functionality of the computer 302 may be accessible for all service consumers using this service layer. Software services, such as those provided by the service layer 313, provide reusable, defined business functionalities through a defined interface. For example, the interface may be software written in JAVA, C++, or other suitable language providing data in extensible markup language (XML) format or another suitable format. While illustrated as an integrated component of the computer 302, alternative implementations may illustrate the API 312 or the service layer 313 as stand-alone components in relation to other components of the computer 302 or other components (whether or not illustrated) that are communicably coupled to the computer 302. Moreover, any or all parts of the API 312 or the service layer 313 may be implemented as child or sub-modules of another software module, enterprise application, or hardware module without departing from the scope of this disclosure.

The computer 302 includes an interface 304. Although illustrated as a single interface 304 in FIG. 3, two or more interfaces 304 may be used according to particular needs, desires, or particular implementations of the computer 302. The interface 304 is used by the computer 302 for communicating with other systems in a distributed environment that are connected to the network 330. Generally, the interface 304 includes logic encoded in software or hardware (or a combination of software and hardware) and operable to communicate with the network 330. More specifically, the interface 304 may include software supporting one or more communication protocols associated with communications such that the network 330 or interface's hardware is operable to communicate physical signals within and outside of the illustrated computer 302.

The computer 302 includes at least one computer processor 305. Although illustrated as a single computer processor 305 in FIG. 3, two or more processors may be used according to particular needs, desires, or particular implementations of the computer 302. Generally, the computer processor 305 executes instructions and manipulates data to perform the operations of the computer 302 and any networks, methods, functions, processes, flows, and procedures as described in the instant disclosure.

The computer 302 also includes a memory 306 that holds data for the computer 302 or other components (or a combination of both) that can be connected to the network 330. For example, memory 306 can be a database storing data consistent with this disclosure. Although illustrated as a single memory 306 in FIG. 3, two or more memories may be used according to particular needs, desires, or particular implementations of the computer 302 and the described functionality. While memory 306 is illustrated as an integral component of the computer 302, in alternative implementations, memory 306 can be external to the computer 302.

The application 307 is an algorithmic software engine providing functionality according to particular needs, desires, or particular implementations of the computer 302, particularly with respect to functionality described in this disclosure. For example, application 307 can serve as one or more components, modules, applications, etc. Further, although illustrated as a single application 307, the application 307 may be implemented as multiple applications 307 on the computer 302. In addition, although illustrated as integral to the computer 302, in alternative implementations, the application 307 can be external to the computer 302.

There may be any number of computers 302 associated with, or external to, a computer system containing computer 302, wherein each computer 302 communicates over network 330. Further, the term “client,” “user,” and other appropriate terminology may be used interchangeably as appropriate without departing from the scope of this disclosure. Moreover, this disclosure contemplates that many users may use one computer 302, or that one user may use multiple computers 302.

One or more embodiments disclosed herein relate to a computer-implemented method automating addition of make-up water. In general, water content in gas streams is a function of pressure and temperature. The computer-implemented method automating addition of make-up water incorporates a pressure-temperature correlation to accurately determine the amount of water lost or added by different gas streams. The method of one or more embodiments may include acquiring pressure and temperature transmitter readings (PI tags) of feed gas, sweet gas, flash gas and acid gas streams in real-time and developing an overall water mass balance program which incorporates a pressure-temperature correlation. The method of one or more embodiments determines the quantities of water lost from treated and acid gas streams of an amine-based gas treating system.

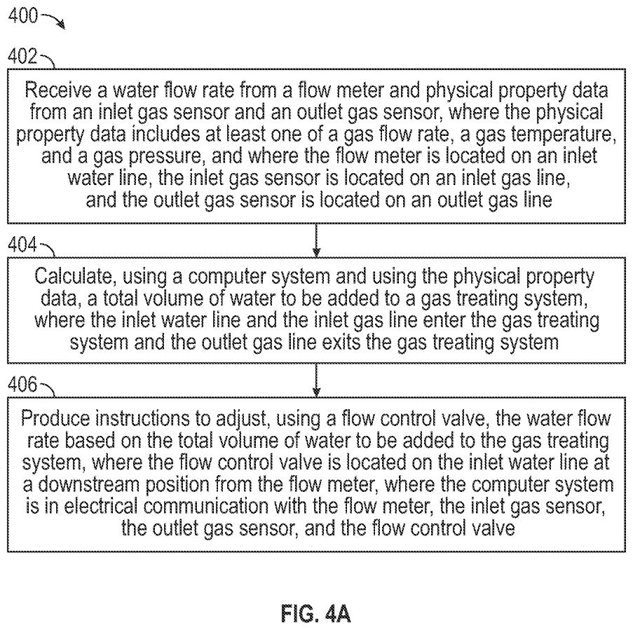

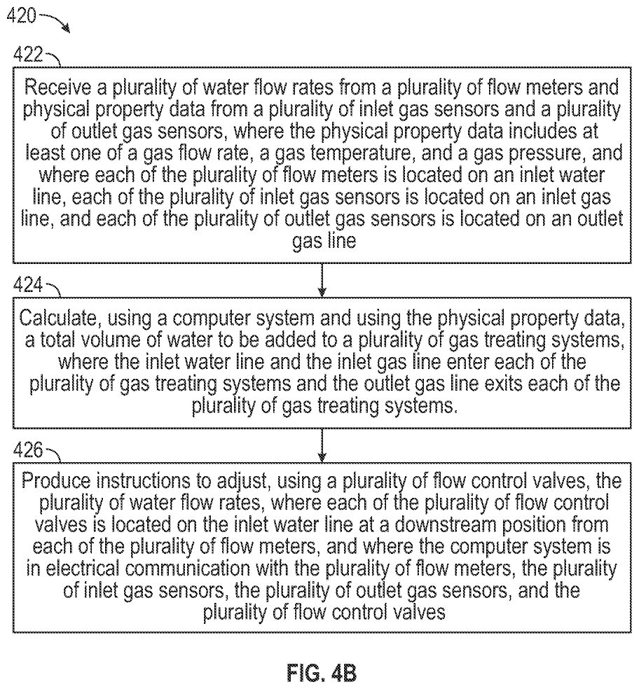

FIG. 4A is a flowchart of a computer-implemented method automating addition of make-up water according to one or more embodiments. The method 400 of one or more embodiments shown in FIG. 4A includes, in step 402, receiving a water flow rate from a flow meter and physical property data from an inlet gas sensor and an outlet gas sensor, where the physical property data includes at least one of a gas flow rate, a gas temperature, and a gas pressure, and where the flow meter is located on an inlet water line, the inlet gas sensor is located on an inlet gas line, and the outlet gas sensor is located on an outlet gas line.

The method 400 of one or more embodiments shown in FIG. 4A includes, in step 404, calculating, using a computer system and using the physical property data, a total volume of water to be added to a gas treating system, where the inlet water line and the inlet gas line enter the gas treating system and the outlet gas line exits the gas treating system. In some embodiments, the method 400 also includes calculating, using the physical property data, a mol percent (mol %) of water in the inlet gas line and the outlet gas line using equation 1:

$$m = \text{} 0.002108 ( \frac{1}{{P}_{f} + 14.7} ) * EXP ( - \frac{6 859.74}{{T}_{f} + 376.588} + 25.10931 ) + EXP ( - \frac{7 89.07}{{T}_{f} + 459.7} + 15.38136 ) , \qquad ( Equation 1 )$$

where P_{f} is a gas pressure, T_{f} is a gas temperature, and m is the mol % of water present in a gas line. According to one or more embodiments disclosed herein, P_{f} and T_{f} are acquired using a plurality of sensors coupled to a gas stream. Equation 1 provides a value having units of mol % of water. Therefore, the method of one or more embodiments further includes converting a mol % of water to a volume of total water lost using the molar mass of water and Avogadro's number, as would be understood by one of ordinary skill in the art.

In some embodiments, the method 400 also includes calculating, using the computer system, the physical property data, equation 1 and equation 2, a total volume of water lost from outlet gas line exiting the gas treating system,

$${V}_{L} = {\sum }_{0}^{{x}_{o u t}} \frac{{m}_{x}}{100} {F}_{x} \frac{M {W}_{{H}_{2} O}}{{ρ}_{{H}_{2} O}} , \qquad ( Equation 2 )$$

where V_{L} is the total volume of water lost from the outlet gas line exiting the gas treating system, xₒᵤₜ is a total number of outlet gas lines exiting the gas treating system, mₓ is a mol % of water present in an xth gas stream (calculated using equation 1), and Fₓ is a gas flow rate of an xth gas line, MW_{H2O} is a molecular weight of water, and ρ_{H2O} is a density of water assuming standard temperature and pressure.

In some embodiments, the method 400 also includes calculating, using the computer system, the physical property data, equation 1, and equation 3, a total volume of water added from the inlet gas line entering the gas treating system:

$${V}_{A} = {\sum }_{0}^{{x}_{i n}} \frac{{m}_{x}}{100} {F}_{x} \frac{M {W}_{{H}_{2} O}}{{ρ}_{{H}_{2} O}} , \qquad ( Equation 3 )$$

where V_{A} is the total volume of water added from the inlet gas line entering the gas treating system, xᵢₙ is a total number of inlet gas lines entering the gas treating system.

In some embodiments, the method 400 also includes calculating, using the computer system, a total volume of water to be added to the gas treating system, using equation 4:

$${V}_{T} = {V}_{L} - {V}_{A} , \qquad ( Equation 4 )$$

where V_{T} is the total volume of water to be added to the gas treating system, V_{L} is the total volume of water lost from the outlet gas line, and V_{A} is the total volume of water added from the inlet gas line.

The method 400 also includes, in step 406, producing instructions to adjust, using a flow control valve, the water flow rate based on the total volume of water to be added to the gas treating system, where the flow control valve is located on the inlet water line at a downstream position from the flow meter, where the computer system is in electrical communication with the flow meter, the inlet gas sensor, the outlet gas sensor, and the flow control valve. In some embodiments, the method 400 further includes receiving a water level from a level-indicating transmitter located on a water collection system and providing instructions to a level control valve to maintain a desired water level in the water collection system by adjusting a water source flow rate of a water source to match the total volume of water to be added to the gas treating system, where the water source is fluidly connected to an upstream side of the water collection system and the level control valve is located on a make-up water line exiting the water collection system, and where the computer system is in electrical communication with the level-indicating transmitter and the level control valve.

FIG. 4B is a flowchart of a computer-implemented method for automating addition of make-up water according to one or more embodiments. The method 420 of one or more embodiments shown in FIG. 4B includes, in step 422, receive a plurality of water flow rates from a plurality of flow meters and physical property data from a plurality of inlet gas sensors and a plurality of outlet gas sensors. The physical property data includes at least one of a gas flow rate, a gas temperature, and a gas pressure, and each of the plurality of flow meters is located on an inlet water line. Each of the plurality of inlet gas sensors is located on an inlet gas line, and each of the plurality of outlet gas sensors is located on an outlet gas line.

The method 420 also includes, in step 424, calculating, using a computer system and using the physical property data, a total volume of water to be added to a plurality of gas treating systems. The inlet water line and the inlet gas line enter each of the plurality of gas treating systems and the outlet gas line exits each of the plurality of gas treating systems.

In some embodiments, the method 420 includes calculating, using the computer system and the physical property data for each of the plurality of gas treating systems, a mol % of water in the inlet gas line and the outlet gas line using equation 1:

$$m = 0.0 \; 02108 ( \frac{1}{{P}_{f} + 14.7} ) * EXP ( - \frac{6 859.74}{{T}_{f} + 376.588} + 25.109 \; 31 ) + EXP ( - \frac{7 89.07}{{T}_{f} + 459.7} + 15.38136 ) , \qquad ( Equation 1 )$$

where P_{f} is a gas pressure, T_{f} is a gas temperature, and m is the mol % of water present in a gas line.

In some embodiments, the method 420 includes calculating, using the computer system and the physical property data for each of the plurality of gas treating systems, a total volume of water lost from the outlet gas line exiting a yth gas treating system, using equation 1 and equation 5,

$${V}_{L , y} = {\sum }_{1}^{y} {\sum }_{0}^{{x}_{out , y}} \frac{{m}_{x}}{100} {F}_{x} \frac{{MW}_{{H}_{2} O}}{{ρ}_{{H}_{2} O}} , \qquad ( Equation 5 )$$

where y is a total number of gas treating systems, V_{L,y} is a total volume of water lost from the outlet gas line exiting the yth gas treating system, x_{out,y} is a total number of outlet gas lines exiting the yth gas treating system, mₓ is a mol % of water present in an xth gas stream (calculated using equation 1), Fₓ is a gas flow rate of an xth gas line, MW_{H2O} is a molecular weight of water, and ρ_{H2O} is a density of water.

In some embodiments, the method 420 includes calculating, using the computer system and the physical property data for each of the plurality of gas treating systems, a total volume of water lost from the outlet gas line exiting the yth gas treating system, using equation 1 and equation 6,

$${V}_{A , y} = {\sum }_{1}^{y} {\sum }_{0}^{{x}_{in , y}} \frac{{m}_{x}}{100} {F}_{x} \frac{{MW}_{{H}_{2} O}}{{ρ}_{{H}_{2} O}} , \qquad ( Equation 6 )$$

where V_{A,y} is the total volume of water added from the inlet gas line entering the yth gas treating system, x_{in,y} is a total number of inlet gas lines entering the yth gas treating system.

In some embodiments, the method 420 includes calculating, using the computer system, the total volume of make-up water to be added to the plurality of gas treating systems, using equation 7:

$${V}_{T} = {\sum }_{1}^{y} {V}_{T , y} = {\sum }_{1}^{y} ( {V}_{L , y} - {V}_{A , y} ) , \qquad ( Equation 7 )$$

where V_{T} is the total volume of make-up water added to each of the plurality of gas treating systems, and V_{T,y} is a total volume of water to be added to a yth gas treating system.

The method 420 also includes, in step 426, producing instructions to adjust, using a plurality of flow control valves, the plurality of water flow rates, where each of the plurality of flow control valves is located on the inlet water line at a downstream position from each of the plurality of flow meters. The computer system is in electrical communication with the plurality of flow meters, the plurality of inlet gas sensors, the plurality of outlet gas sensors, and the plurality of flow control valves.

In some embodiments, the method 420 also includes calculating, for each of the plurality of gas treating systems, a ratio control value, wherein the ratio control value represents a percentage of water to be added to each of y gas treating systems, using equation 8:

$${RC}_{y} = \frac{{V}_{T , y}}{{V}_{T}} , \qquad ( Equation 8 )$$

where RC_{y} is the ratio control value for a yth inlet water line, and providing instructions, using the computer system, to adjust a flow rate of a yth inlet water line, using a yth flow control valve disposed on the yth inlet water line, based on the ratio control value for the yth inlet water line calculated using equation 7, where the yth inlet water line is fluidly connected upstream of the yth gas treating system.

In some embodiments, the method 420 also includes receiving a water level from a level-indicating transmitter located on a water collection system and providing instructions to a level control valve to maintain a desired water level in the water collection system by adjusting a water source flow rate to match the total volume of make-up water to be added to the plurality of gas treating systems. A water source is fluidly connected to an upstream side of the water collection system and wherein the level control valve is located on a make-up water line exiting the water collection system, and the computer system is in electrical communication with the level-indicating transmitter and the level control valve.

Embodiments of the present disclosure may provide at least one of the following advantages. The automation of water make-up according to one or more embodiments will ensure adding quantities of water in proportion to losses in order to maintain amine solution strength within acceptable range. Hence, automation of water make-up in amine-based gas treating systems will enhance the performance of overall gas treating process by maintaining amine solution strength within acceptable limits and also will prevent solvent losses and associated costs significantly while minimizing impacts to downstream sulfur plant operation due to carry-over of degraded amine and other contaminants through excess water. This idea can be implemented in existing facilities as well as new design to optimize performance of overall gas treating performance.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system to automate addition of make-up water, comprising:
a water collection system, comprising;
a level-indicating transmitter,
a make-up water line, and
a water source,
wherein the water source is fluidly connected to an upstream side of the water collection system and wherein the make-up water line exits the water collection system,
at least one gas treating system, comprising:
a flow control valve on an inlet water line,
an inlet gas sensor on an inlet gas line, and
an outlet gas sensor on an outlet gas line,
wherein the inlet gas line and the inlet water line enter the at least one gas treating system and the outlet gas line exits the at least one gas treating system,
a flow meter on an adjusted make-up water line,
wherein the flow meter is located between the water collection system and the flow control valve; and
a computer system configured to:
receive a water flow rate from the flow meter and at least one physical property from the inlet gas sensor and the outlet gas sensor,
calculate a total volume of water to be added to the at least one gas treating system, and
produce instructions to adjust, using the flow control valve, the water flow rate based on the total volume of water to be added to the at least one gas treating system,
wherein the computer system is in electrical communication with the flow meter, the inlet gas sensor, the outlet gas sensor, and the flow control valve.

2. The system of claim 1 wherein the at least one physical property comprises one or more of a gas flow rate, a gas pressure, and a gas temperature.

3. The system of claim 1, wherein the computer system is further configured to:
receive a water level from the level-indicating transmitter; and
provide instructions to a level control valve to maintain a desired water level in the water collection system by adjusting a water source flow rate from the water source to match the water flow rate from the flow meter,
wherein the level control valve is located on the make-up water line, and
wherein the computer system is in electrical communication with the level-indicating transmitter and the level control valve.

4. The system of claim 1, wherein the at least one gas treating system is an amine-based gas treating system.

5. The system of claim 1, wherein the computer system is further configured to calculate, using the at least one physical property from the inlet gas sensor, a mol % of water present in the inlet gas line and a total volume of water added to the at least one gas treating system from the inlet gas line.

6. The system of claim 1, wherein the computer system is further configured to calculate, using the at least one physical property from the outlet gas sensor, a mol % of water present in the outlet gas line and a total volume of water lost from the at least one gas treating system from the outlet gas line.

7. The system of claim 6, wherein the total volume of water to be added to the at least one gas treating system comprises a difference between the total volume of water lost from the outlet gas line and the total volume of water added from the inlet gas line.

8. A computer-implemented method for automating addition of make-up water, comprising:
receiving a water flow rate from a flow meter and physical property data from an inlet gas sensor and an outlet gas sensor,
wherein the physical property data comprises at least one of a gas flow rate, a gas temperature, and a gas pressure, and
wherein the flow meter is located on an inlet water line, the inlet gas sensor is located on an inlet gas line, and the outlet gas sensor is located on an outlet gas line;
calculating, using a computer system and using the physical property data, a total volume of water to be added to a gas treating system,
wherein the inlet water line and the inlet gas line enter the gas treating system and the outlet gas line exits the gas treating system; and
producing instructions to adjust, using a flow control valve, the water flow rate based on the total volume of water to be added to the gas treating system,
wherein the flow control valve is located on the inlet water line at a downstream position from the flow meter,
wherein the computer system is in electrical communication with the flow meter, the inlet gas sensor, the outlet gas sensor, and the flow control valve.

9. The computer-implemented method of claim 8, further comprising:
calculating, using the physical property data, a mol % of water in the inlet gas line and the outlet gas line using equation 1:
$$m = 0.002108 ( \frac{1}{{P}_{f} + 14.7} ) * EXP ( - \frac{6859.74}{{T}_{f} + 376.588} + 25.10931 ) + EXP ( - \frac{7089.07}{{T}_{f} + 459.7} + 15.38136 ) \qquad ( Equation 1 )$$
where P_{f} is a gas pressure, T_{f} is a gas temperature, and m is the mol % of water present in a gas line.

10. The computer-implemented method of claim 9, further comprising:
$${V}_{L} = {\sum }_{0}^{{x}_{out}} \frac{{m}_{x}}{100} {F}_{x} \frac{{MW}_{{H}_{2} O}}{{ρ}_{{H}_{2} O}}$$
calculating, using the computer system, the physical property data, equation 1 and equation 2, a total volume of water lost from outlet gas line exiting the gas treating system,
$${V}_{L} = {\sum }_{0}^{{x}_{out}} \frac{{m}_{x}}{100} {F}_{x} \frac{{MW}_{{H}_{2} O}}{{ρ}_{{H}_{2} O}} \qquad ( Equation 2 )$$
wherein V_{L} is the total volume of water lost from the outlet gas line exiting the gas treating system, xₒᵤₜ is a total number of outlet gas lines exiting the gas treating system, mₓ is a mol % of water present in an xth gas stream (calculated using equation 1), and Fₓ is a gas flow rate of an xth gas line, MW_{H}_{₂}_{O} is a molecular weight of water, and ρ_{H}_{₂}_{O} is a density of water.

11. The computer-implemented method of claim 10, further comprising:
calculating, using the computer system, the physical property data, equation 1, and equation 3, a total volume of water added from the inlet gas line entering the gas treating system:
$${V}_{A} = {\sum }_{0}^{{x}_{in}} \frac{{m}_{x}}{100} {F}_{x} \frac{{MW}_{{H}_{2} O}}{{ρ}_{{H}_{2} O}} \qquad ( Equation 3 )$$
$${V}_{A} = {\sum }_{0}^{{x}_{in}} \frac{{m}_{x}}{100} {F}_{x} \frac{{MW}_{{H}_{2} O}}{{ρ}_{{H}_{2} O}}$$
wherein V_{A} is the total volume of water added from the inlet gas line entering the gas treating system, xᵢₙ is a total number of inlet gas lines entering the gas treating system.

12. The computer-implemented method of claim 11, further comprising:
calculating, using the computer system, a total volume of water to be added to the gas treating system, using equation 4:
$${V}_{T} = {V}_{L} - {V}_{A} \qquad ( Equation 4 )$$
wherein V_{T} is the total volume of water to be added to the gas treating system, V_{L} is the total volume of water lost from the outlet gas line, and V_{A} is the total volume of water added from the inlet gas line.

13. The computer-implemented method of claim 8, further comprising:
receiving a water level from a level-indicating transmitter located on a water collection system; and
providing instructions to a level control valve to maintain a desired water level in the water collection system by adjusting a water source flow rate of a water source to match the total volume of water to be added to the gas treating system,
wherein the water source is fluidly connected to an upstream side of the water collection system and the level control valve is located on a make-up water line exiting the water collection system, and
wherein the computer system is in electrical communication with the level-indicating transmitter and the level control valve.

14. A computer-implemented method for automating addition of make-up water, comprising:
receiving a plurality of water flow rates from a plurality of flow meters and physical property data from a plurality of inlet gas sensors and a plurality of outlet gas sensors, wherein the physical property data comprises at least one of a gas flow rate, a gas temperature, and a gas pressure, and
wherein each of the plurality of flow meters is located on an inlet water line, each of the plurality of inlet gas sensors is located on an inlet gas line, and each of the plurality of outlet gas sensors is located on an outlet gas line;
calculating, using a computer system and using the physical property data, a total volume of water to be added to a plurality of gas treating systems,
wherein the inlet water line and the inlet gas line enter each of the plurality of gas treating systems and the outlet gas line exits each of the plurality of gas treating systems; and
producing instructions to adjust, using a plurality of flow control valves, the plurality of water flow rates,
wherein each of the plurality of flow control valves is located on the inlet water line at a downstream position from each of the plurality of flow meters, and
wherein the computer system is in electrical communication with the plurality of flow meters, the plurality of inlet gas sensors, the plurality of outlet gas sensors, and the plurality of flow control valves.

15. The computer-implemented method of claim 14, further comprising:
calculating, using the computer system and the physical property data for each of the plurality of gas treating systems, a mol % of water in the inlet gas line and the outlet gas line using equation 1:
$$m = 0.002108 ( \frac{1}{{P}_{f} + 14.7} ) * EXP ( - \frac{6859.74}{{T}_{f} + 376.588} + 25.10931 ) + EXP ( - \frac{7089.07}{{T}_{f} + 459.7} + 15.38136 ) \qquad ( Equation 1 )$$
wherein P_{f} is a gas pressure, T_{f} is a gas temperature, and m is the mol % of water present in a gas line.

16. The computer-implemented method of claim 15, further comprising:
calculating, using the computer system and the physical property data for each of the plurality of gas treating systems, a total volume of water lost from the outlet gas line exiting a yth gas treating system, using equation 1 and equation 5,
$${V}_{L , y} = {\sum }_{1}^{y} {\sum }_{0}^{{x}_{out , y}} \frac{{m}_{x}}{100} {F}_{x} \frac{{MW}_{{H}_{2} O}}{{ρ}_{{H}_{2} O}} \qquad ( Equation 5 )$$
$${V}_{L , y} = {\sum }_{1}^{y} {\sum }_{0}^{{x}_{out , y}} \frac{{m}_{x}}{100} {F}_{x} \frac{{MW}_{{H}_{2} O}}{{ρ}_{{H}_{2} O}}$$
wherein y is a total number of gas treating systems, V_{Ly} is a total volume of water lost from the outlet gas line exiting the yth gas treating system, x_{out,y} is a total number of outlet gas lines exiting the yth gas treating system, mₓ is a mol % of water present in an xth gas stream (calculated using equation 1), Fₓ is a gas flow rate of an xth gas line, MW_{H2O} is a molecular weight of water, and ρ_{H2O} is a density of water.

17. The computer-implemented method of claim 16, further comprising:
calculating, using the computer system and the physical property data for each of the plurality of gas treating systems, a total volume of water lost from the outlet gas line exiting the yth gas treating system, using equation 1 and equation 6,
$${V}_{A , y} = {\sum }_{1}^{y} {\sum }_{0}^{{x}_{in , y}} \frac{{m}_{x}}{100} {F}_{x} \frac{{MW}_{{H}_{2} O}}{{ρ}_{{H}_{2} O}}$$
$${V}_{A , y} = {\sum }_{1}^{y} {\sum }_{0}^{{x}_{in , y}} \frac{{m}_{x}}{100} {F}_{x} \frac{{MW}_{{H}_{2} O}}{{ρ}_{{H}_{2} O}} \qquad ( Equation 6 )$$
wherein V_{A,y} is the total volume of water added from the inlet gas line entering the yth gas treating system, x_{in,y} is a total number of inlet gas lines entering the yth gas treating system.

18. The computer-implemented method of claim 17, further comprising:
Calculating, using the computer system, the total volume of make-up water to be added to the plurality of gas treating systems, using equation 7:
$${V}_{T} = {\sum }_{1}^{y} {V}_{T , y} = {\sum }_{1}^{y} ( {V}_{L , y} - {V}_{A , y} ) \qquad ( Equation 7 )$$
wherein V_{T} is the total volume of make-up water added to each of the plurality of gas treating systems, and V_{T,y} is a total volume of water to be added to a yth gas treating system.

19. The computer-implemented method of claim 18, further comprising:
calculating, for each of the plurality of gas treating systems, a ratio control value, wherein the ratio control value represents a percentage of water to be added to each of y gas treating systems, using equation 8:
$${RC}_{y} = \frac{{V}_{T , y}}{{V}_{T}} \qquad ( Equation 8 )$$
wherein RC_{y} is the ratio control value for a yth inlet water line, and
providing instructions, using the computer system, to adjust a flow rate of a yth inlet water line, using a yth flow control valve disposed on the yth inlet water line, based on the ratio control value for the yth inlet water line calculated using equation 7, wherein the yth inlet water line is fluidly connected upstream of the yth gas treating system.

20. The computer-implemented method of claim 14, further comprising:
receiving a water level from a level-indicating transmitter located on a water collection system; and
providing instructions to a level control valve to maintain a desired water level in the water collection system by adjusting a water source flow rate to match the total volume of make-up water to be added to the plurality of gas treating systems,
wherein a water source is fluidly connected to an upstream side of the water collection system and wherein the level control valve is located on a make-up water line exiting the water collection system, and
wherein the computer system is in electrical communication with the level-indicating transmitter and the level control valve.
